(19) United States
(12) Patent Application Publication
(10) Pub. No.: US 2003/0122099 A1
(43) Pub. Date: Jul. 3, 2003

(54) Valve assembly

(75) Inventors: Yung-Chao Huang, Tainan Hsien (TW); Chi-Chang Yang, Tainan Hsien (TW); Pin-Fu Weng, Tainan City (TW); Yu-Yao Chen, Tainan City (TW)

Correspondence Address: MARGER JOHNSON & McCOLLOM, P.C., 1030 S.W. Morrison Street, Portland, OR, 97205, US

(73) Assignee: Helix Technology Inc., Hsinchu City (TW)

(21) Appl. No.: 10/228,803

(22) Filed: Aug. 26, 2002

(30) Foreign Application Priority Data
Dec. 31, 2001 (TW) 090224298

(51) Int. Cl. F16K 1/16

(52) U.S. Cl. 251/301

(57) ABSTRACT

In a valve assembly, a main frame unit has an inner space defined by opposite side walls connected respectively to lateral walls of adjacent chambers, front and rear walls connected between the side walls, and top and bottom walls disposed on opposing top and bottom ends of the front and rear walls. Each side wall is formed with an access hole for passage of a workpiece into and out of the inner space. The rear wall is formed with a through hole and is mounted detachably with a cover plate for closing the through hole. A valve unit is disposed in the inner space and is movable so as to close the access hole in one of the side walls. A drive unit has a rotary axle disposed rotatably in the inner space and coupled to the valve unit to control closing movement of the valve unit.

### CROSS-REFERENCE TO RELATED APPLICATION

This application claims priority of Taiwanese Application No. 090224298, filed on Dec. 31, 2001.

### BACKGROUND OF THE INVENTION

1. Field of the Invention

The invention relates to a valve assembly, more particularly to a valve assembly adapted to be installed between an adjacent pair of chambers.

2. Description of the Related Art

In a fabrication process for semiconductors, there are many steps that must be run under a vacuum environment. For example, with different vacuum conditions in a thin film deposition process, air flow and deposition speed can be controlled. Moreover, in a vapor deposition and a process and sputtering process, control of the vacuum condition is very important.

A conventional valve device is usually installed between an adjacent pair of vacuum chambers to ensure the different vacuum conditions. However, the conventional valve device is difficult to disassemble when repair of the conventional valve device is required. Furthermore, the operation of the conventional valve device cannot be inspected.

### SUMMARY OF THE INVENTION

Therefore, the object of the present invention is to provide a valve assembly which can overcome the drawbacks associated with the aforesaid prior art. According to the present invention, a valve assembly is adapted to be installed between an adjacent pair of chambers so as to control fluid communication between the chambers. The chambers have confronting lateral walls, each of which is formed with an opening for passage of a workpiece from one of the chambers to the other of the chambers. The valve assembly comprises:

a main frame unit having opposite first and second side walls, each of which is adapted to be connected to a respective one of the lateral walls of the adjacent pair of the chambers, upright front and rear walls connected between the first and second side walls, and top and bottom walls disposed on opposing top and bottom ends of the front and rear walls, the first and second side walls; the front and rear walls, and the top and bottom walls cooperating to define an inner space, each of the first and second side walls being formed with an access hole adapted for passage of the workpiece into and out of the inner space, one of the front and rear walls being formed with a through hole;

a cover plate mounted detachably on said one of the front and rear walls for closing the through hole;

a valve unit disposed in the inner space and movable so as to close the access hole in one of the first and second side walls; and

a drive unit mounted on the main frame unit and having a rotary axle that is disposed rotatably in the inner space and that is coupled to the valve unit to control closing movement of the valve unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing the preferred embodiment of a valve assembly installed between an adjacent pair of chambers according to the present invention;

FIG. 2 is a perspective view showing the preferred embodiment;

FIG. 3 is a schematic sectional view taken along line III-III in FIG. 2 to illustrate a valve unit in a closed position;

FIG. 4 is a schematic sectional view taken along line IV-IV in FIG. 2 to illustrate the valve unit in the closed position;

FIG. 5 is a fragmentary perspective, partly sectional view showing the valve unit of the preferred embodiment; and

FIG. 6 is a schematic sectional view of the preferred embodiment to illustrate the valve unit in an open position.

### DETAILED DESCRIPTION OF THE PREFERRED EMBODIMENT

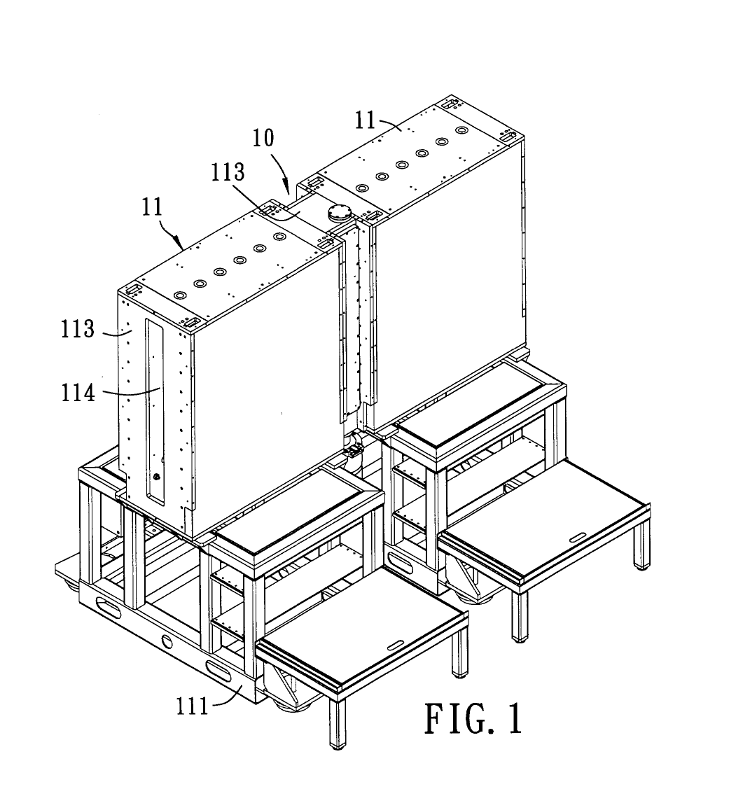

Referring to FIGS. 1 to 4, the preferred embodiment of a valve assembly 10 according to the present invention is shown to be adapted to be installed between an adjacent pair of chambers 11, each of which is mounted on a base frame 111, so as to control fluid communication between the chambers 11. The chambers 11 have confronting lateral walls 113, each of which is formed with an opening 114 for passage of a workpiece (not shown) from one of the chambers 11 to the other of the chambers 11. The valve assembly 10 includes a main frame unit 2, front and rear cover plates 6, 5, a valve unit 4, and a drive unit 3.

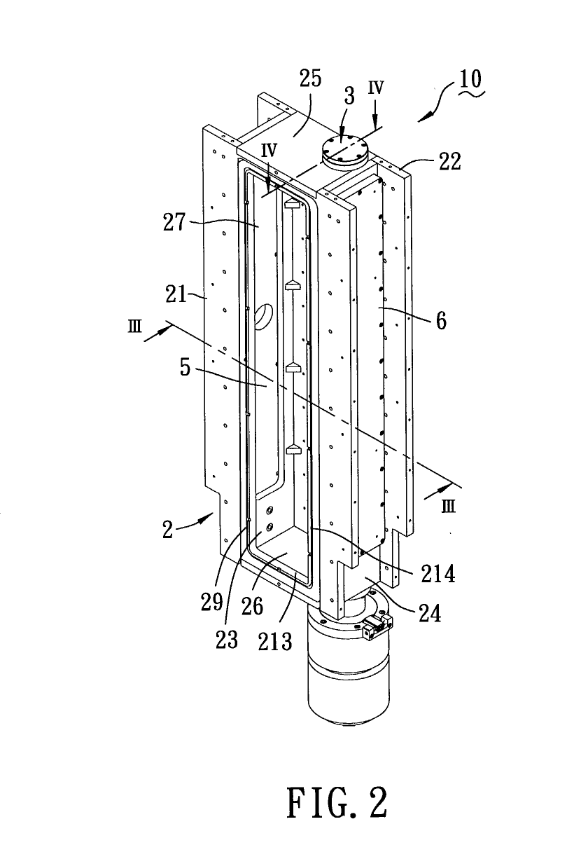

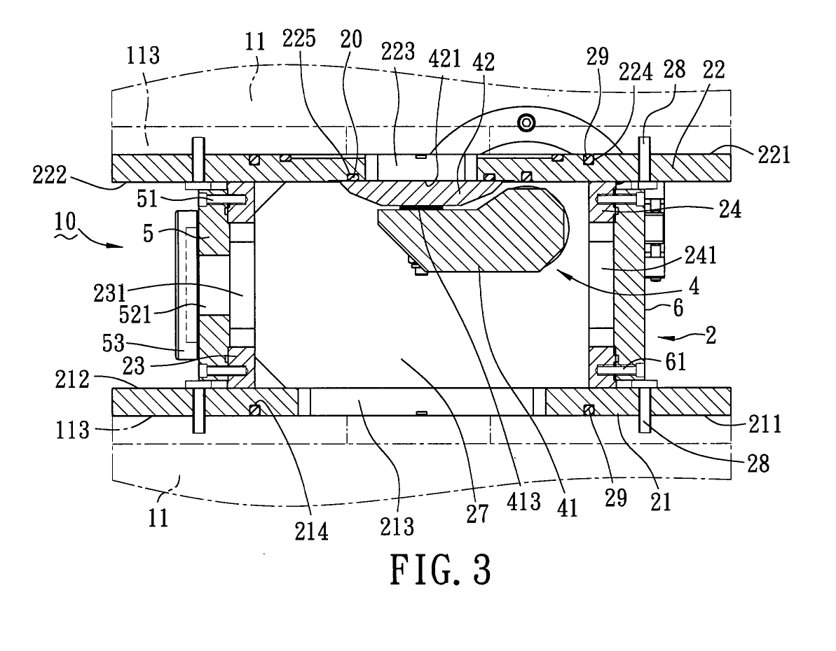

The main frame unit 2 has opposite first and second side walls 21, 22, upright front and rear walls 24, 23 connected between the first and second side walls 21, 22, and top and bottom walls 25, 26 disposed on opposing top and bottom ends of the front and rear walls 24, 23 (see FIG. 2). The first and second side walls 21, 22, the front and rear walls 24, 23, and the top and bottom walls 25, 26 cooperate to define an inner space 27. As shown in FIG. 3, each of the first and second side walls 21, 22 is adapted to be connected to a respective one of the lateral walls 113 of the adjacent pair of the chambers 11 by means of a plurality of fastening bolts 28, and is formed with an access hole 213, 223 adapted for passage of the workpiece into and out of the inner space 27. In this embodiment, the access hole 213 in the first side wall 21 has an area larger than that of the access hole 223 in the second side wall 22. Each of the front and rear walls 24, 23 is formed with a through hole 241, 231.

As shown in FIG. 3, the front cover plate 6 is mounted detachably on the front wall 24 by means of a plurality of fastening bolts 61. The rear cover plate 5 is mounted detachably on the rear wall 23 by means of a plurality of fastening bolts 51, and is formed with a viewing hole 521 that is registered with the through hole 231 in the rear wall 23. A transparent panel 53 is mounted on the rear cover plate 5 to close the viewing hole 521.

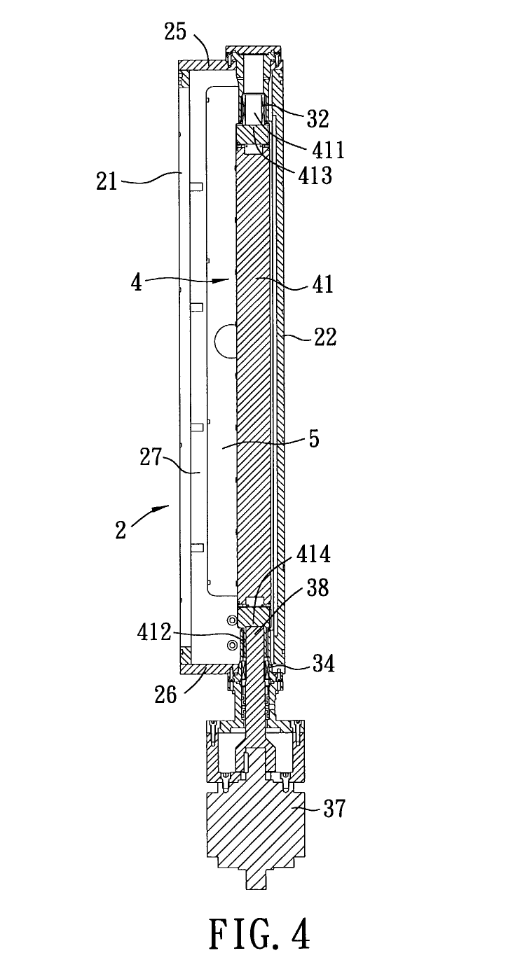

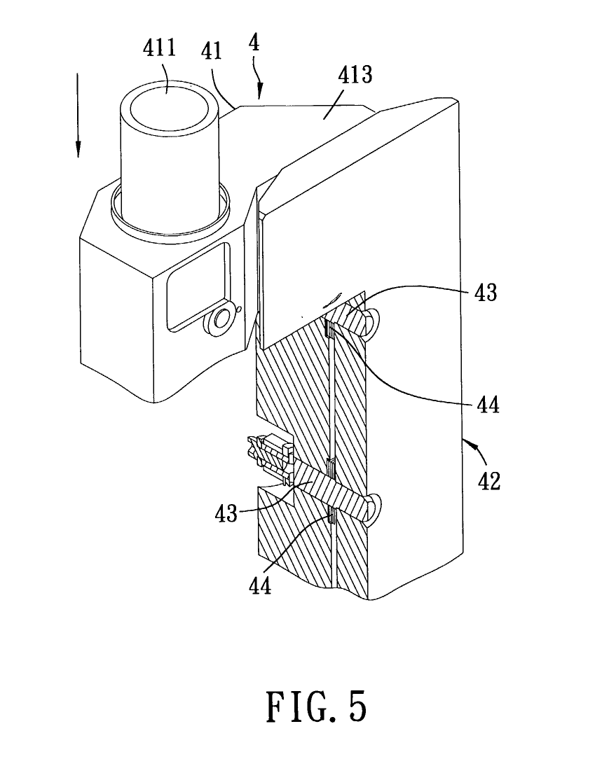

Referring further to FIGS. 4 to 6, the valve unit 4 is disposed in the inner space 27 and is movable so as to close the access hole 223 in the second side wall 22 (see FIG. 3). In this embodiment, the valve unit 4 includes a main valve seat 41 extending between the top and bottom walls 25, 26 and having upper and lower ends 413, 414, and a pressing block 42 connected to the main valve seat 41 by means of a plurality of fastening pieces 43 for abutting against the second side wall 22 so as to close the access hole 223 in the second side wall 22. The upper and bottom ends 413, 414 are provided with hollow first and second positioning posts 411, 412, respectively. The valve unit 4 further includes a biasing member mounted between the main valve seat 41 and the pressing block 42 for biasing the pressing block 42 to contact tightly the second side wall 22 when the pressing block 42 closes the access hole 223 in the second side wall 22 (see FIG. 3). In this embodiment, the biasing member includes a plurality of disk springs 44, each of which is sleeved on a respective one of the fastening pieces 43 (see FIG. 5).

A first sealing unit is provided around the access hole 223 in the second side wall 22 and between the valve unit 4 and the second side wall 22 to ensure sealing engagement between the valve unit 4 and the second side wall 22 when the valve unit 4 closes the access hole 223 in the second side wall 22. In this embodiment, the first sealing unit includes a receiving groove 225 formed in an inner surface 222 of the second side wall 22, and a sealing ring 20 disposed in the receiving groove 225, as shown in FIG. 3.

A second sealing unit is provided around the access holes 213, 223 in the first and second side walls 21, 22 and is adapted to ensure sealing engagement between the first and second side walls 21, 22 and the lateral walls 113 of the adjacent pair of the chambers 11. In this embodiment, the second sealing unit includes two receiving grooves 214, 224 formed in outer surfaces 211, 221 of the first and second side walls 21, 22, respectively, and two sealing rings 29 disposed in the receiving grooves 214, 224, respectively, as shown in FIG. 3.

Referring further to FIG. 4, the drive unit 3 is mounted on the main frame unit 2 and has a rotary axle 38 that is disposed rotatably in the inner space 27 and that is coupled to the lower positioning post 412 of the main valve seat 41 of the valve unit 4 to control closing movement of the valve unit 4. The drive unit 3 includes a rotary drive member 37 mounted on the bottom wall 26 and driving the rotary axle 38. In this embodiment, the rotary drive member 37 includes a rotary cylinder. An upper bearing unit 32 mounts rotatably the valve unit 4 on the top wall 25 of the main frame unit 2. The upper positioning post 411 of the main valve seat 41 of the valve unit 4 is coupled to the upper bearing unit 32. A lower bearing unit 34 mounts rotatably the rotary axle 38 on the bottom wall 26 of the main frame unit 2.

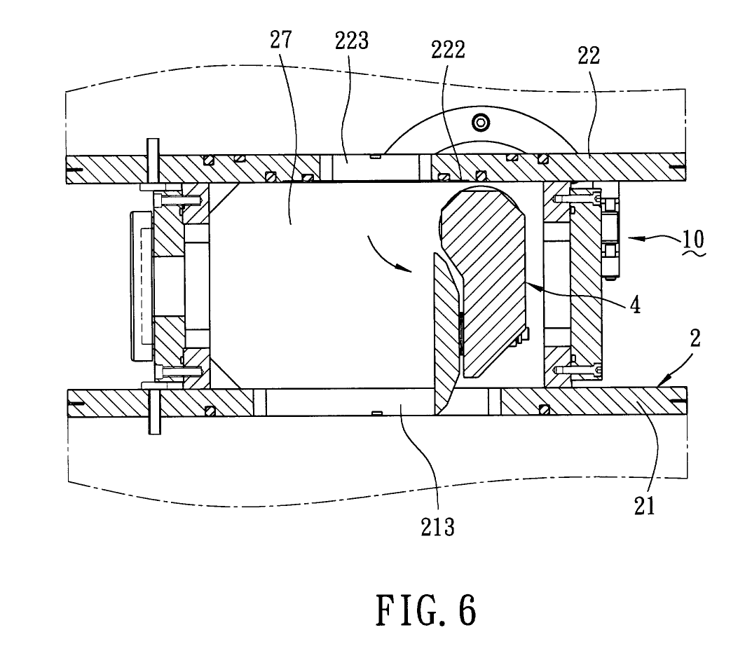

Accordingly, when the valve unit 4 is in a closed position shown in FIG. 3, the valve unit 4 closes tightly the access hole 223 in the second side wall 22 so as to terminate fluid communication between the chambers 11 such that vacuum and processing conditions in each chamber 11 can be independently controlled. When the rotary drive member 37 drives rotatably the rotary axle 38 so as to drive the valve unit 4 to move from the closed position to an open position shown in FIG. 6, the workpiece is permitted to pass through the valve assembly 10.

During use, the operating state of the valve unit 4 in the inner space 27 can be viewed via the transparent panel 53 on the rear cover plate 5. As such, when the valve unit 4 is out of order, the front or rear cover plate 6 or 5 can be easily detached from the main frame unit 2 so as to facilitate repair of the valve unit 4 by way of the through hole 241 or 231 in the front or rear walls 24 or 23.

Therefore, due to the presence of the viewing hole 521 in the rear cover plate 5, operation of the valve unit 4 of the valve assembly 10 of this invention can be viewed. Moreover, due to the design of the detachable front and rear cover plates 6, 5, repair of the valve unit 4 is facilitated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A valve assembly adapted to be installed between an adjacent pair of chambers so as to control fluid communication between the chambers, the chambers having confronting lateral walls, each of which is formed with an opening for passage of a workpiece from one of the chambers to the other of the chambers, said valve assembly comprising:
a main frame unit having opposite first and second side walls, each of which is adapted to be connected to a respective one of the lateral walls of the adjacent pair of the chambers, upright front and rear walls connected between said first and second side walls, and top and bottom walls disposed on opposing top and bottom ends of said front and rear walls, said first and second side walls; said front and rear walls, and said top and bottom walls cooperating to define an inner space, each of said first and second side walls being formed with an access hole adapted for passage of the workpiece into and out of said inner space, one of said front and rear walls being formed with a through hole;
a cover plate mounted detachably on said one of said front and rear walls for closing said through hole;
a valve unit disposed in said inner space and movable so as to close said access hole in one of said first and second side walls; and
a drive unit mounted on said main frame unit and having a rotary axle that is disposed rotatably in said inner space and that is coupled to said valve unit to control closing movement of said valve unit.

2. The valve assembly as claimed in claim 1, further comprising a seal unit provided around said access hole in said one of said first and second side walls and between said valve unit and said one of said first and second side walls to ensure sealing engagement between said valve unit and said one of said first and second side walls when said valve unit closes said access hole in said one of said first and second side walls.

3. The valve assembly as claimed in claim 1, further comprising a seal unit provided around said access hole in one of said first and second side walls and adapted to ensure sealing engagement between said one of said first and second side walls and the respective one of the lateral walls of the chambers.

4. The valve assembly as claimed in claim 1, wherein said drive unit includes a rotary drive member mounted on said bottom wall and driving rotatably said rotary axle.

5. The valve assembly as claimed in claim 4, further comprising an upper bearing unit for mounting rotatably said valve unit on said top wall, and a lower bearing unit for mounting rotatably said rotary axle on said bottom wall.

6. The valve assembly as claimed in claim 5, wherein said valve unit includes a main valve seat extending between said top and bottom walls and having upper and lower ends, and a pressing block connected to said main valve seat for abutting against said one of said first and second side walls to close said access hole in said one of said first and second side walls, said upper end of said main valve seat being coupled to said upper bearing unit, said lower end of said main valve seat being coupled to said rotary axle.

7. The valve assembly as claimed in claim 6, wherein said valve unit further includes a biasing member mounted between said main valve seat and said pressing block for biasing said pressing block to contact tightly said one of said first and second side walls when said pressing block closes said access hole in said one of said first and second side walls.

8. The valve assembly as claimed in claim 4, wherein said rotary drive member includes a rotary cylinder.

9. The valve assembly as claimed in claim 1, wherein said cover plate is formed with a viewing hole that is registered with said through hole in said one of said front and rear walls, said valve assembly further comprising a transparent panel mounted on said cover plate to close said viewing hole.
